(19) United States
(12) Patent Application Publication
(10) Pub. No.: US 2025/0035598 A1
(43) Pub. Date: Jan. 30, 2025

(54) HIGH PERFORMANCE LIQUID CHROMATOGRAPHY PUMP, AND LIQUID CHROMATOGRAPHY SYSTEM COMPRISING SAME

(71) Applicant: Practichem LLC, Raleigh, NC (US)

(72) Inventor: Nicholas Michael DeMarco, Raleigh, NC (US)

(21) Appl. No.: 18/782,209

(22) Filed: Jul. 24, 2024

Related U.S. Application Data
(60) Provisional application No. 63/515,246, filed on Jul. 24, 2023.

(51) Int. Cl. G01N 30/32; B01D 15/16; G01N 30/02

(52) U.S. Cl. CPC G01N 30/32; B01D 15/163; G01N 2030/027; G01N 2030/326; G01N 2030/328

(57) ABSTRACT

A liquid pump is described, including two pumplet subassemblies, each including an actuator and a pump head, and a controller adapted to provide smooth flow at a command rate. Each pumplet subassembly sequentially, cyclically, and repetitively operates (i) in a first operational active dispensing stage and (ii) in a refilling and transitional repressurization in a second operational non-dispensing standby stage. The controller switches the active dispensing operation from the active pumplet subassembly to the alternate and non-dispensing pumplet subassembly in which refilled liquid has been pressurized in the transitional repressurization operation in the alternate and non-dispensing pumplet subassembly to match active dispensing pressure of the active pumplet subassembly.

### CROSS-REFERENCE TO RELATED APPLICATION

The benefit under 35 USC § 119 of U.S. Provisional Patent Application 63/515,246 filed Jul. 24, 2023 in the name of Nicholas Michael DeMarco for HIGH PERFORMANCE LIQUID CHROMATOGRAPHY PUMP, AND LIQUID CHROMATOGRAPHY SYSTEM COMPRISING SAME is hereby claimed, and the disclosure thereof is hereby incorporated by reference herein in its entirety, for all purposes.

### FIELD

The present disclosure generally relates to liquid pumps and liquid chromatography systems comprising same, and in specific implementations relates to a liquid pump of a modular character that can be used in a cartridge format for ready installation, actuation, operation, and deinstallation in liquid chromatography systems.

### BACKGROUND

In liquid chromatography systems, pumps of widely varying types are utilized to effect delivery of solvents, buffers, samples, etc. at controlled rates and flow conditions in the system to provide the requisite interaction of the mobile phase with a stationary phase material producing eluate for detection of analytes and corresponding generation of chromatographic data for analysis.

To minimize noise, drift, and other error-introducing anomalies in the detection process, it is essential that the pumps utilized in the chromatography system deliver precision-metered smooth flow of liquids throughout their operating regimes, particularly at lowest flow rates at highest pressures. This is particularly important in chromatography systems in which flow circuitry contains multiple pumps that are arranged for coordinated operation and switching, and that require flow transitions that are free of even low-level spikes, surges, and other adverse liquid flow phenomena.

The art continues to seek improved liquid chromatography system pumps that are compact, light in weight, operationally quiet, reliable, easily maintained, and capable of ready installation in and removal from the liquid chromatography systems in which they are deployed.

### SUMMARY

The present disclosure generally relates to liquid pumps and to chromatography systems comprising same.

In one aspect, the disclosure relates to a liquid pump, comprising: two pumplet subassemblies, each comprising an actuator and a pump head; a controller adapted to coordinate operation of the two pumplet subassemblies to provide smooth flow at a command rate so that in liquid dispensing operation each pumplet subassembly sequentially, cyclically, and repetitively operates (i) as an active pumplet subassembly in a first operational dispensing stage and then (ii) as an alternate and non-dispensing pumplet subassembly in a refilling and transitional repressurization in a second operational standby stage, so that each pumplet subassembly correspondingly alternates between active dispensing operation in the first operational dispensing stage, and refilling and transitional repressurization operation in the second operational standby stage, with the controller switching the active dispensing operation from the active pumplet subassembly to the alternate and non-dispensing pumplet subassembly in which refilled liquid has been pressurized in the transitional repressurization operation in the alternate and non-dispensing pumplet subassembly to match active dispensing pressure of the active pumplet subassembly.

In another aspect, the disclosure relates to a liquid chromatography system comprising a pump according to the present disclosure as variously described herein.

Other aspects, features and embodiments of the disclosure will be more fully apparent from the ensuing description and appended claims.

### BRIEF DESCRIPTION OF THE DRAWINGS

FIG. 1 is a perspective view of a liquid chromatography system according to one aspect of the present disclosure.

FIG. 2 is an exploded perspective view of the pump cartridge, showing the components thereof.

FIG. 3A is a perspective view of the pumplet top housing member showing the interior thereof, and FIG. 3B is a perspective view of the pumplet bottom housing member showing the interior thereof.

FIG. 4 is a perspective view of the bearing tube of the pumplet subassembly.

FIG. 5 is a perspective view of the diaphragm of the pumplet subassembly.

FIG. 6 is a perspective view of the headcap of the pumplet subassembly.

FIG. 7A is a perspective view of the outlet tower of the pumplet subassembly, and FIGS. 7B is a corresponding wireframe renderings of the outlet tower, showing the details of internal construction thereof.

FIG. 8 is a perspective view of the sleeve of the pumplet subassembly.

FIG. 9 is a perspective view of the chamber of the pumplet subassembly.

FIG. 10 is a perspective view of the inlet tower of the pumplet subassembly.

FIG. 11 is a perspective view of the endcap of the pumplet subassembly.

FIG. 12 is a perspective view of the female plunger connector of the pumplet subassembly.

FIG. 13 is a perspective view of the rinse fitting of the pumplet subassembly.

FIG. 14 is a perspective view of the assembled pumplet subassembly.

FIG. 15 is a perspective view showing a pump module comprising two pumplet subassemblies.

FIG. 16 is a reverse rear perspective view of the pump module of FIG. 15.

FIG. 17 is a perspective view of a liquid chromatography system according to another embodiment of the present disclosure, similar to the liquid chromatography system shown in FIG. 1, and including wing assemblies configured for positional management of flow circuitry tubing in the liquid chromatography system.

FIG. 18 is a front perspective view of a valve module of the liquid chromatography system of FIG. 17.

FIG. 19 is a rear perspective view of the valve module of FIG. 18.

FIG. 20 is a front perspective view of a detector module of the liquid chromatography system of FIG. 17.

FIG. 21 is a schematic depiction of the interconnecting structure of successive tray sections in the tiered stacked array of tray sections in the liquid chromatography system of FIG. 17.

FIG. 22 is a schematic depiction of the interconnecting coupling structure of a wing member and respective tray sections in the tiered stacked array of tray sections in the liquid chromatography system of FIG. 17.

### DETAILED DESCRIPTION

The present disclosure relates generally to liquid chromatography pumps, and to liquid chromatography systems comprising same.

In one aspect, the disclosure relates to a pump of the dual positive displacement plunger type, comprising two identical pumplet subassemblies, each comprising an actuator and a pump head and a controller arranged to coordinate operation of the two pumplet subassemblies to provide smooth flow at a command rate.

In operation, the pumplet subassemblies cooperatively transfer fluid from their inlet ports to their outlet ports, progressing through operational stages in which each pumplet subassembly sequentially and cyclically and repetitively operates (i) as an active pumplet subassembly in a first operational dispensing stage and then (ii) as an alternate and non-dispensing pumplet subassembly in a second refilling and standby operational stage. Each pumplet subassembly correspondingly alternates between the refilling and standby operation and the active dispensing operation, in the following sequence of steps: delivery; refill; and transition.

In the delivery step, the plunger of the active pumplet subassembly advances into the pump chamber, reducing the working volume of the pump chamber to create dispensing flow from the active pumplet subassembly.

In the subsequent refill step, the plunger of the now non-dispensing alternate pumplet subassembly is retracted to refill the pump chamber, while the plunger of the other previously filled pumplet subassembly is advanced in dispensing operation. The refilling of the now non-dispensing alternate pumplet subassembly is controlled so that the refilling is completed in less time than the dispensing operation conducted in the other now active dispensing pumplet subassembly, to allow time for the refilled pumplet subassembly to accommodate pre-compression in the transition step.

In the transition step, as the active dispensing pumplet subassembly approaches the end of its stroke, the plunger in the refilled standby pumplet subassembly is advanced to compress the refill liquid to match the pump's current operating pressure, but without any dispensing from the pressurizing standby pumplet subassembly, with the plunger of the active subassembly slowing while the plunger in the standby pumplet subassembly accelerates. The active-to-standby pumplet transition stage begins as the active pumplet plunger decelerates to its end of travel, with the standby pumplet recompression being complete before this stage begins. The controller then effects the switching of the pumplets so that the dispensing operation is transferred from the formerly active pumplet subassembly to the pressurized standby pumplet subassembly, so that the latter commences dispensing operation, while the formerly active pumplet subassembly then undergoes refill and transition steps in the above-described manner, to achieve continuity of dispensing operation. At the transfer of dispensing operation from the formerly active pumplet subassembly to the pressurized standby pumplet subassembly, the velocity vectors of the respective plungers in the two pumplet subassemblies are constant.

The pump is arranged to receive operational commands from the controller to adjustably modulate the pump operation, and the pump is arranged so that, for example, upon receiving an operational command to increase its flow rate, the refill velocity of the plunger in the alternate pumplet subassembly is adjusted so that the refilling of the pump chamber in such alternate pumplet is completed in a correspondingly shorter period of time to accommodate the transfer of dispensing operation at the command increased flow rate.

The pump thus is modulated by the controller during active operation, and the controller can be operated to place the pump in a shut down or “parked” state, in which the plungers in both pumplet subassemblies are fully extended into their respective pump chambers, for storage or transport of the pump. The pump in its original manufactured form may be provided with actuators of the plungers in the respective pumplet subassemblies being in a retracted position.

The pump is advantageously constructed and arranged so that a pump head of the pump can be removed and exchanged with a replacement pump head, without using any mechanical tools in the removal and replacement operations, by corresponding software control. This significantly simplifies the pump head exchange operation. In an illustrative implementation of such pump head exchange, a user of the pump initiates the pump head exchange through an instrument interface, at which the user is prompted to disconnect tubing connections of the associated flow circuitry from the pump head.

The user then commands the system to release the pump head, resulting in a corresponding control signal being sent to the actuator plunger driver so that the plunger driver effects movement of the plunger to a hyper retraction point, which disconnects the plunger male connector connection spring from the plunger female connector groove, and disengages the actuator's pump head retention tabs from the grooves in the pump head. The user then is instructed at the instrument interface to remove the pump head by withdrawing the head from the actuator's receiver, with the subsequent pump head removal being sensed by a male plunger linear position sensor.

In the pump head replacement sequence, the actuator's plunger driver extends to the pump head load position, at which the pump head retention tabs relax, but are free to be lifted. The user is instructed at the instrument interface to insert the replacement pump head, pressing it into the actuator receiver until it clicks in place. At this point, the pump head retention tabs drop into the pump head grooves. The pump head then cannot be removed from this position, since the retention tab leading edges include a wedge, where the trailing sides are squared. Pump head insertion is sensed by the aforementioned position sensor.

In the subsequent reconnection step, the actuator plunger driver fully extends, driving the plunger to a hard stop within the pump head. The plunger male connector is forced into the plunger female connector, the pump being parked and ready to begin normal operation.

Considering now the features and components of the pump in further detail, the pump head is a variable volume displacement pump, in which the volume is varied as the plunger is advanced into a chamber bounded by a plunger seal. Flow direction is maintained by two sets of non-return valves that direct fluid up through the pump. The pump heads advantageously are fabricated to be renewable, e.g., by delivery to the manufacturer or supplier for rebuilding involving replacement of specific components, while enabling cleaning and use of other high-value components.

The pump chamber in the pump is a hollow cylinder with a barrel vaulted ceiling structure, with one end of the chamber being closed and the other open to receive a movable plunger. A seal gland receives a plunger seal. The chamber is connected to inlet and outlet ports.

The pump comprises two valve towers including non-return valve stacks that allow flow upwards from a bottom inlet to a top outlet, with reverse flow being blocked. Each valve assembly is a stack of two ball and seat groups and a plain spacer at the bottom of the tower assembled into a header that connects the pump chamber to a tube fitting.

Each valve tower and stack is sealed against a chamber port by force applied by a cam-in-groove mechanism. The plain spacer rides along a radial groove with constantly increasing radius cut into the outside of the chamber. During assembly, this mechanism increases pressure on each of the valve headers as the chamber is rotated inside of the sleeve.

The chamber inlet port is located at the lower proximal end of the chamber, nearest the closed end. The chamber outlet port is located at the upper distal end, in the barrel vaulted ceiling. adjacent to the plunger seal. Such port positioning, in conjunction with the barrel vaulted ceiling, concentrates entrained gas bubbles in a small volume, from which higher linear velocity transports them to the outlet port.

Each non-return valve set comprises two ball and seat pairs. The ball in the ball and seat may be of any suitable type and material of construction, and may for example comprise a spherical polished ruby ball. The seat may likewise be of any suitable type and material of construction, and may for example comprise a sapphire ring with a polished inner edge, so that the mating surface formed by the engagement of the seat and ball seals at a theoretically perfect circle. The ball is enclosed in a ball spacer that allows the ball to move, but maintains the valve stack integrity around the ball. The ball spacer includes a slot configured so that fluid can flow around the ball in one direction.

Each header contains two valve sets in a series arrangement for redundancy, as a safeguard against a failure of one of the two valves. The header includes a fitting port suitable for tube connection. In various embodiments, the inlet may employ a luer inlet fitting since the inlet essentially only experiences atmospheric or sub-atmospheric pressures, and the outlet may employ a high pressure fitting suitable for high-pressure connections in the chromatography system, e.g., a 10-32 cone fitting.

The outlet header includes a manual prime and purge valve, which when open allows a user to connect a syringe to the outlet fluid conduit to prime the pump, or allows bubbles to be vented.

The pump includes a plunger and male plunger connector, in which the male plunger connector connects the plunger to the actuator. The plunger may be heat shrink assembled into the plunger connector, or the plunger may be associated with the plunger connector by other connector devices or couplings, and/or be assembled or formed by other assembly or forming techniques. The female plunger connector is formed so that it can be readily disconnected from the actuator, and the connection and disconnection forces may be of any suitable magnitudes and ratios with respect to one another. As an illustrative example, in specific embodiments, the connection force may be approximately 25% of the disconnection force, as provided by a canted coil spring and appropriate geometry of the connecting parts.

The chamber open end is capped by a headcap, concentrically mounted to the chamber, with a plunger seal gland formed into these two parts. The headcap also maintains the bearing tube concentric to the plunger's motion axis. The headcap does not contact the primary liquids, but it does contact the rinse fluid. The headcap receives mechanical connectors, e.g., screws, to secure the pump chamber assembly in fully assembled form. The distal side of the headcap is part of the rinse system of the pump. Rinse fluid inlet and outlet fittings are disposed in the headcap ports. Bore clearance is provided in the headcap to accommodate fluid flow around the plunger, rinsing it and removing any collected salts. The rinse fluid may be of any suitable type, and may for example comprise 20 vol. % ethanol in water, wherein such volume percent is based on the total volume of the rinse fluid, although the disclosure is not limited thereto, and other aqueous ethanolic solutions, or other rinse fluids, may be employed.

The rinse system functions as a secondary pump in which pumping action is achieved via a flexible diaphragm, which drags on the plunger to cause the flexible diaphragm to flex in alternating directions. Such action varies the volume in the rinse locus, allowing fluid to be moved. A flexible tube connects the rinse fluid reservoir to a lower rinse fitting. A corresponding upper rinse fitting connects to the headcap upper rinse port. The upper fitting includes a non-return valve.

The plunger female connector reciprocates within the bearing tube, which is concentric with the plunger axis. The bearing portion keeps the plunger coaxial with the pump seal. The bearing tube is formed with suitable features to retain the rinse diaphragm on the headcap, to ensure a liquid tight connection. The bearing tube also retains the rinse fittings, pressing them against receiving recesses in the headcap, to ensure a liquid tight seal. The bearing tube also limits plunger connector forward travel, and such limit is utilized in plunger reconnection during pump head replacement, as previously described.

The pump head upper housing and pump head lower housing hold the internal pump head components in alignment, and maintain seal force on the elastomeric seal rinse diaphragm. The pump head housing distal end includes engagement elements to mate with the pump actuator's head retention tabs, as previously described.

As a safety and integrity measure, the assembled pump head may include a recess adapted to receive a wrap-around decal covering the housing mate line and indicating whether the pump head has been disassembled. The decal may be of any suitable type, and may for example be printed with a traceable unique identifier, such as a model and serial identification.

The pump actuator in the pump is a linear actuator that includes features to sense, connect, and release the pump head. A motor and ball screw may be employed as a motive driver for the pump, with the ball screw mounted in a thrust and radial bearing assembly to take up reaction force from the pump, and with the actuator constructed and arranged to resist pump head connection and disconnection forces. The motor may be of any suitable type, and may for example comprise a stepper motor, such as a NEMA 17 stepper motor commercially available from Nanotec Electronic U.S. Inc., Auburn, MA.

The plunger driver may be formed in half sections that are assembled to the ball nut, with the ball nut in such assembly converting motor rotary motion into linear motion, and converting torque to force. The male plunger connector connects to the female plunger connector in the pump head. The plunger driver is vented so that air is not forced through the ball nut or around the ball screw, since this would remove lubrication from the ball screw and shorten the actuator's service life.

The pump actuator housing holds the assembly of linear actuator components. The housing also mounts the motor, contains the thrust bearing, and prevents the plunger driver from rotating. The plunger driver includes a cam mechanism and the actuator housing pump head includes a retention tab that follows the cam profile. The plunger driver cam drives the retention tab upwardly to unlatch the pump, and in another cam position, the cam locks the retention tab down to prevent it from unlatching from the pump head.

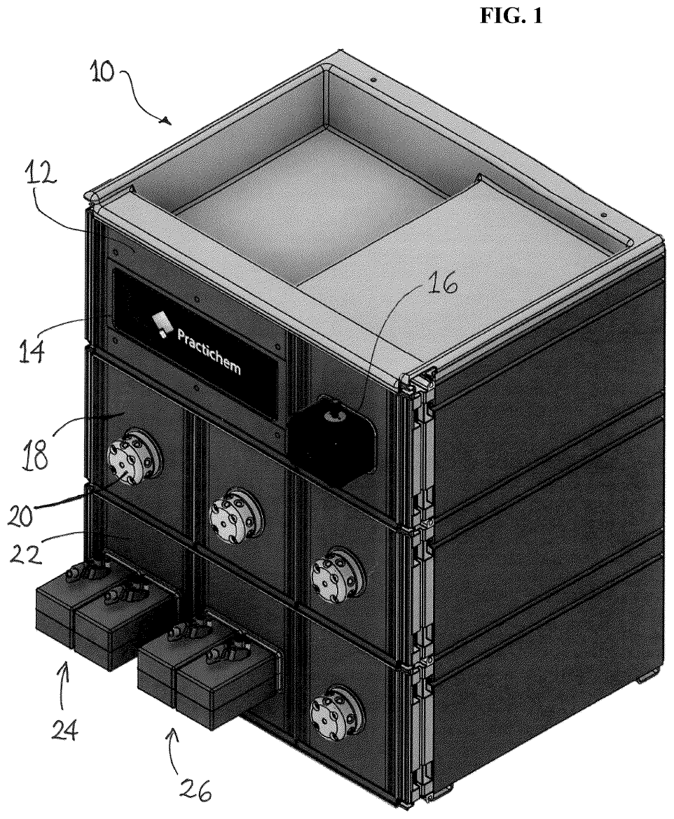

Referring now to the drawings, FIG. 1 is a perspective view of a liquid chromatography system 10 according to one aspect of the present disclosure. The chromatography system comprises a tiered stacked array of respective tray sections, the top tray section 12 including a touch screen input/output display 14, and a detector module 16, the middle tray section 18 including valve modules 20, and the bottom tray section 22 including pump modules 24 and 26.

The pump modules 24 and 26 each comprise two pump cartridges, as respective pumplet subassemblies of the pump.

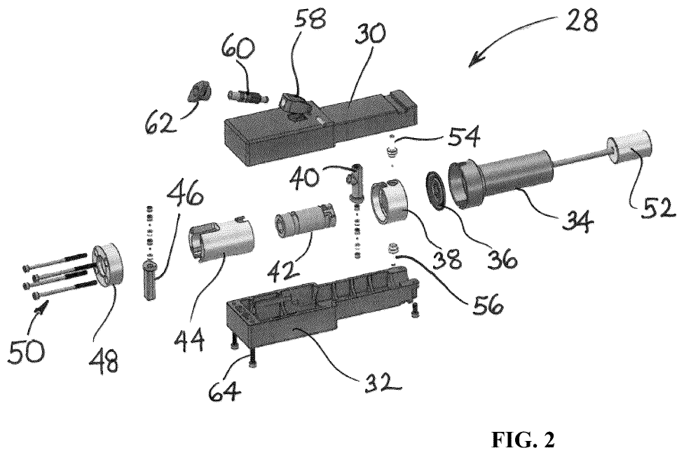

FIG. 2 is an exploded perspective view of a corresponding pump cartridge 28, showing the components thereof. As shown, the pump cartridge includes a pumplet top housing member 30 and comprises a liquid outlet 58, to which is attached a liquid outlet fitting 60 and a liquid outlet coupling 62 for connecting the liquid outlet to flow circuitry (not shown in FIG. 2) such as tubing or other flow circuitry components to which the pumped liquid is dispensed in the operation of the pumplet when in active dispensing operation.

The pump cartridge includes a female plunger connector 52, and bearing tube 34 in which the plunger connected to the plunger connector is translated in the operation of the pump cartridge. A diaphragm 36 is arranged to be carried on the plunger and to bidirectionally translate in order to effect the rinsing operation. A headcap 38 is arranged to receive the rinse fitting 54 in a port opening of the headcap, with such rinse fitting having a distal end extending through a port opening in the pumplet top housing member 30 to discharge rinse fluid from the rinse locus as a result of deflection of the diaphragm 36 during travel of the plunger. The headcap 38 also has a lower port opening (not shown in FIG. 2) in which is disposed a rinse fitting 56 arranged to receive rinse liquid from a corresponding rinse liquid reservoir (not shown in FIG. 2) that is coupled with the rinse fitting 56 via tubing or other flow circuitry components, so that the rinse liquid introduced through the headcap lower rinse liquid port flows through the rinse locus to the headcap upper rinse liquid port for discharge from the pump cartridge.

Adjacent to the headcap 38 in the exploded view of FIG. 2 is an outlet tower 40 in which pumped liquid in the active dispensing operation of the pump cartridge is flowed to the liquid outlet 58 on the pumplet top housing member 30 and thence to flow circuitry coupled with the liquid outlet. The outlet tower contains sealing and flow control elements as schematically shown below the outlet tower.

The pump cartridge includes a chamber 42 in which the plunger is translated in the active dispensing operation of the pump cartridge, and is reversely translated in the subsequent refilling operation of the pump cartridge and in the subsequent repressurizing operation to prepare the pump cartridge for resumed active dispensing operation, while the active dispensing operation is conducted by the other pump cartridge in the pump module.

The chamber 42 is interiorly disposed in the sleeve 44 in the assembled pump cartridge, and the sleeve contains cutouts at its respective ends to accommodate the outlet tower 40 at one end thereof and the inlet tower 46 at the other end thereof, so that the inlet and outlet towers are coupled in fluid flow communication with the chamber 42. The headcap 38 likewise contains a cutout to facilitate retention of the outlet tower in position when the pump cartridge is fully assembled, with the headcap 38 and sleeve 44 in abutting relationship with one another so that their respective cutouts circumscribe the base of the outlet tower to fixedly secure the outlet tower in position. The inlet tower 46 is received in a lower cutout in the sleeve and held in position by the endcap 48, which is secured to the sleeve by mechanical fasteners 50 such as screws, bolts, or other suitable connectors. The inlet tower 46, like the outlet tower 40, contains sealing and flow control elements, as schematically shown above the outlet tower in the FIGS. 2 exploded drawing of the pump cartridge. Liquid to be pumped by the pump cartridge is correspondingly introduced by the inlet tower 46 to the chamber 42, from which it is pumped at the pressure and flow rate commanded by the associated controller (not shown in FIG. 2), and discharged in the outlet tower 40 to the liquid outlet 58 for flow via connected flow circuitry to the stationary phase column for separation and subsequent flow of the eluate to the detector module of the chromatography system for chromatographic detection and outputting of chromatographic data.

The pump cartridge further comprises a pumplet bottom housing member 32 that is engageably matable with the pumplet top housing member 30, with the pumplet top and bottom housing members being secured to one another by the mechanical fasteners 64 shown in association with the pumplet bottom housing member 32 in the FIG. 2 drawing.

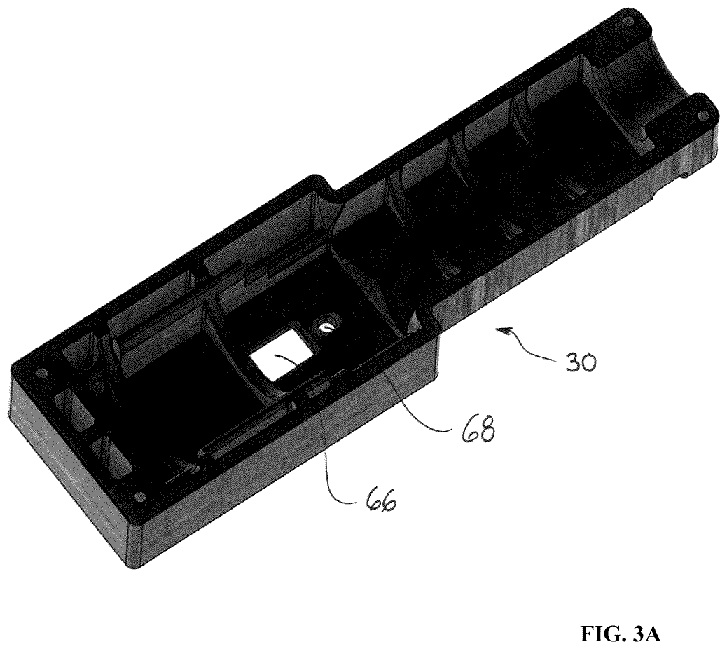

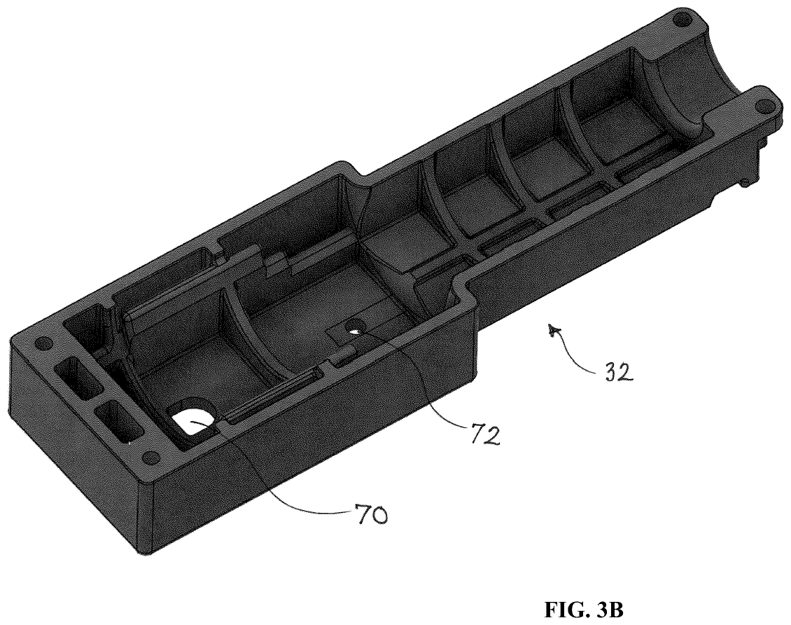

FIG. 3A is a perspective view of the pumplet top housing member 30 showing the interior thereof, with a liquid outlet opening 66 accommodating the connection of the outlet tower 40 with the liquid outlet 58, and a rinse fitting opening 68 for passage of the distal portion of rinse fitting 54 therethrough, as shown in FIG. 2.

FIG. 3B is a perspective view of the pumplet bottom housing member 32 showing the interior thereof, with a liquid inlet opening 70 accommodating the passage of the inlet tower 46 therethrough, and a rinse fitting opening 72 accommodating passage therethrough of the distal end of the rinse fitting 56, as shown in FIG. 2.

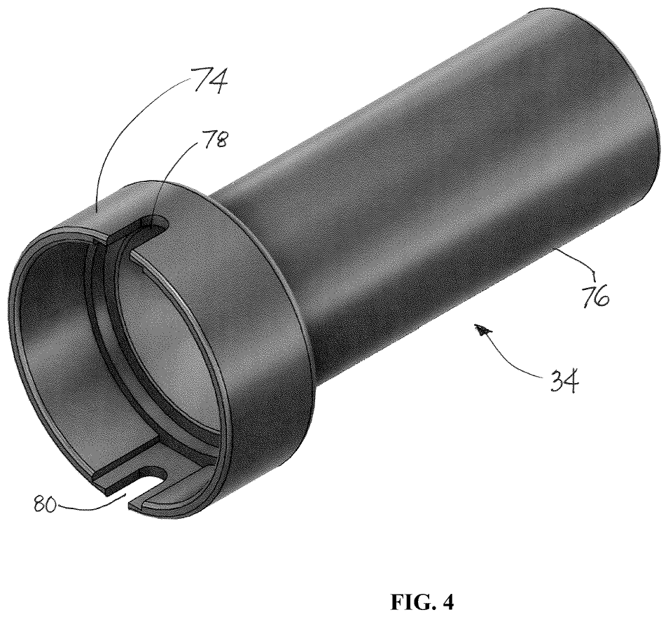

FIG. 4 is a perspective view of the bearing tube 34 of the pumplet subassembly, showing the bearing tube as including a larger diameter proximal cylindrical portion 74 and a smaller diameter main body portion 76, as integrally formed and coaxial with one another. Diametrally opposite cutouts 78 and 80 in the larger diameter cylindrical proximal portion of the bearing tube accommodate the passage therethrough of rinse fittings 54 and 56, respectively.

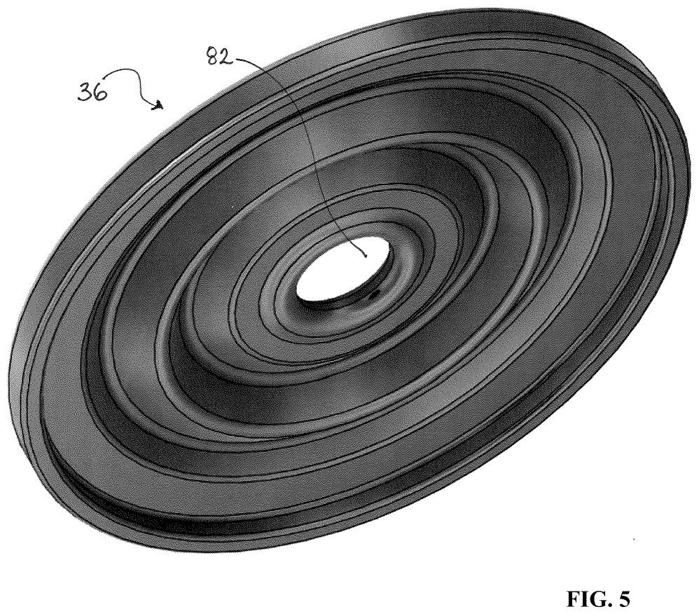

FIG. 5 is a perspective view of the diaphragm 36 of the pumplet subassembly. The diaphragm may be formed of any suitable flexible resilient material of construction and is configured with a central opening 82 through which the shaft of the plunger passes, with the diaphragm being shaped and constructed so that it flexes and deforms during travel of the plunger shaft to effect a rinse liquid pumping action to draw rinse liquid into the rinse locus through the inlet rinse fitting so that the rinse liquid removes salts and other contaminants material from the shaft surface, in a first direction of travel of the plunger shaft, and to discharge rinse liquid from the rinse locus through the outlet rinse fitting, in a second and opposite direction of travel of the plunger shaft, to thereby extend the service life of the pump cartridge.

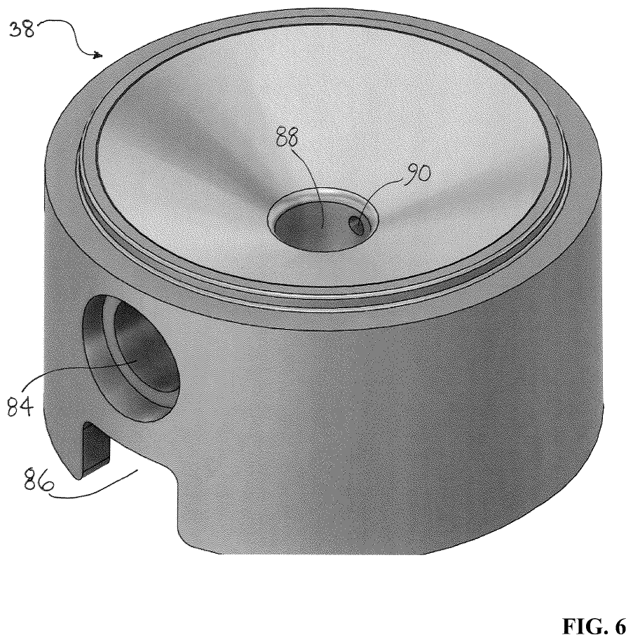

FIG. 6 is a perspective view of the headcap 38 of the pumplet subassembly. The headcap as shown includes a port 84 for coupling to the proximal end of the rinse fitting 54, an outlet tower cutout 86 to facilitate fixed position engagement of the outlet tower 40, a central open plunger shaft passage 88 to accommodate the plunger shaft therein and plunger shaft movement, with a rinse liquid passage 90 from which rinse liquid supplied from a rinse liquid reservoir via the rinse fitting 56 coupled to the headcap is flowed to the rinse locus.

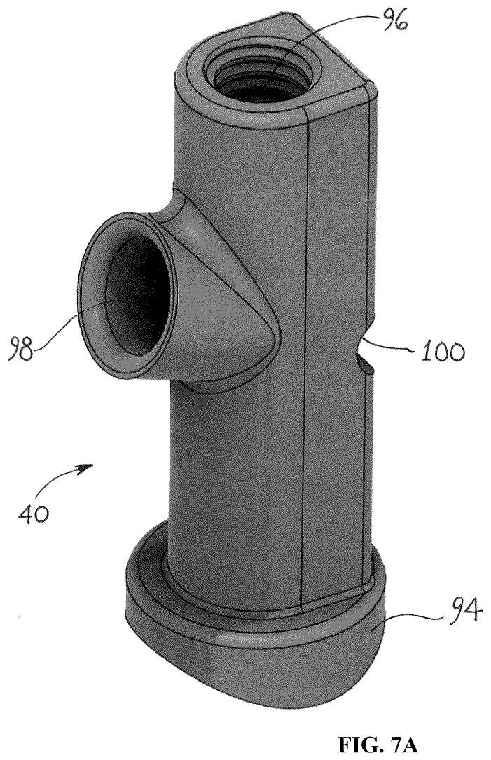

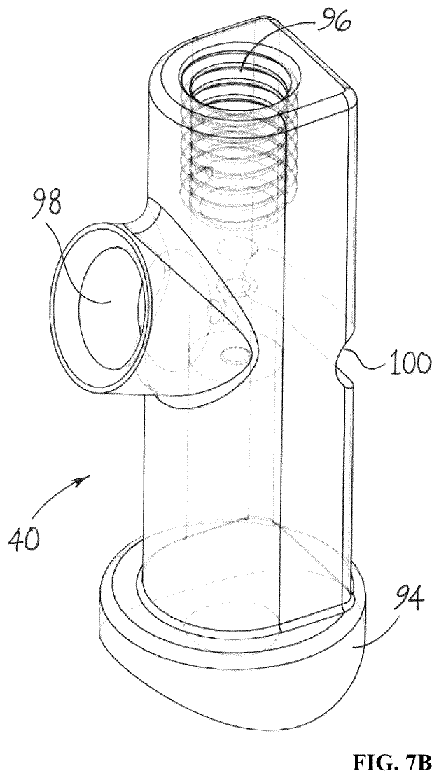

FIG. 7A is a perspective view of the outlet tower 40 of the pumplet subassembly, and FIGS. 7B is a corresponding wireframe rendering of the outlet tower 40, showing the details of internal construction thereof. As illustrated, the outlet tower includes a cam-configured base 94 to enable the outlet tower to be sealed by cam-in-groove engagement with a radial groove of progressively increasing radius in the exterior surface of the chamber. The outlet tower includes an outlet port 96, a purge valve port 98, and a priming injection port 100. The outlet tower contains valve, spacer, and other elements, as previously described.

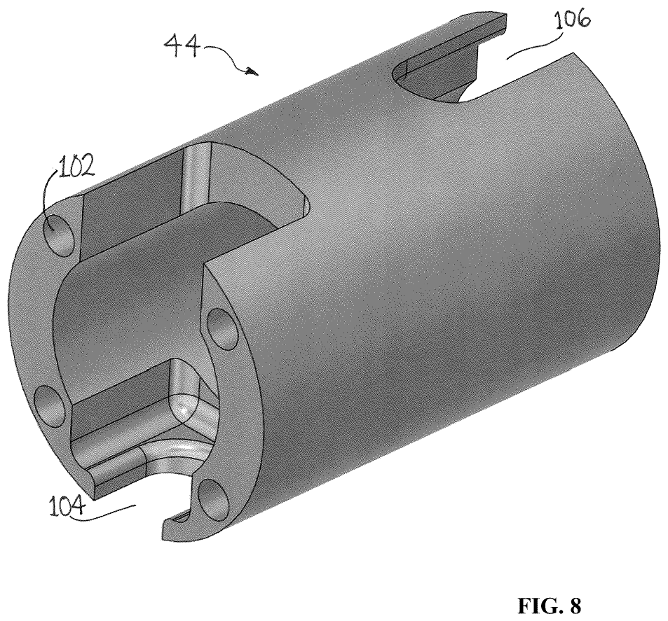

FIG. 8 is a perspective view of the sleeve 44 of the pumplet subassembly. The sleeve contains mechanical fastener passages 102 for threadably engaging the mechanical fasteners 50 as shown in FIG. 2. The sleeve includes a cutout 104 at its proximal lower portion accommodating securement of the inlet tower 46, and a cutout at its upper distal portion accommodating securement of the outlet tower 40, as shown in FIG. 2.

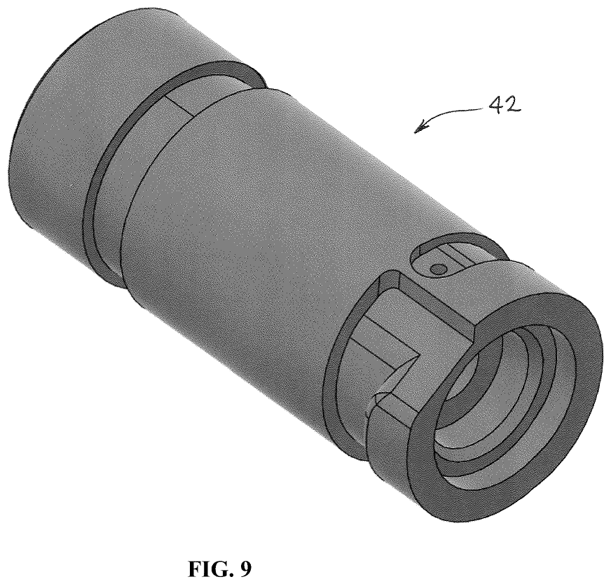

FIG. 9 is a perspective view of the chamber 42 of the pumplet subassembly. The chamber is constructed and arranged as previously described.

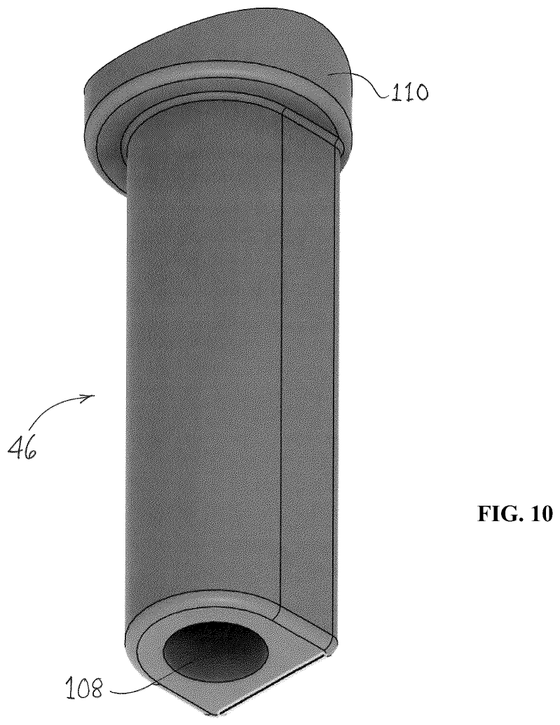

FIG. 10 is a perspective view of the inlet tower 46 of the pumplet subassembly. The inlet tower has an inlet port at its lower end, and a cam-configured head for securement in the sleeve cutout 104 when engaged with the assembled chamber and sleeve elements.

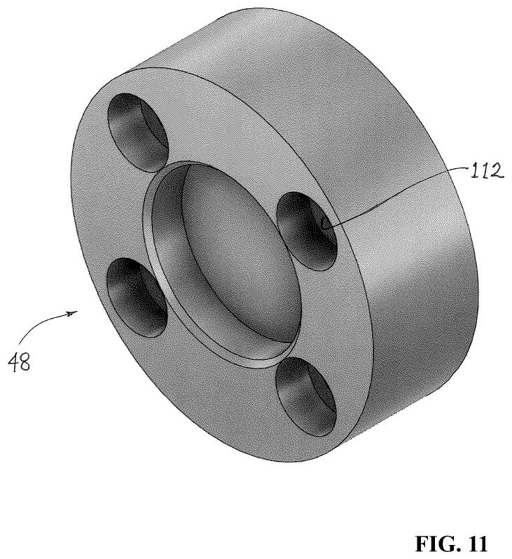

FIG. 11 is a perspective view of the endcap 48 of the pumplet subassembly, showing the endcap as containing mechanical fastener passages 112 that allow the threaded fasteners 50 shown to extend through the endcap and engage with the threaded receiving passages in the sleeve 44, as shown in FIG. 2.

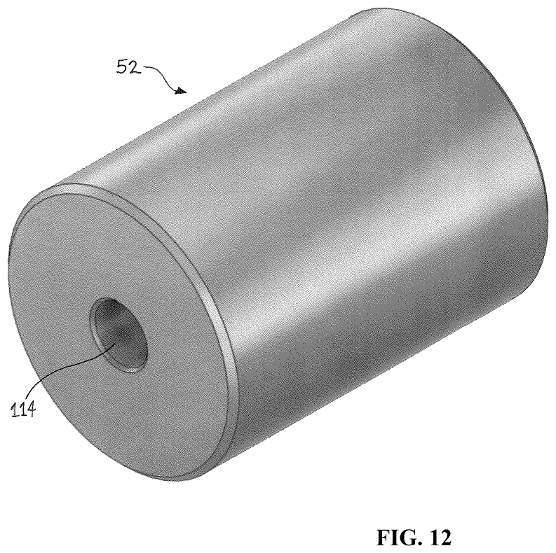

FIG. 12 is a perspective view of the female plunger connector 52 of the pumplet subassembly, which includes a central bore 114 therethrough which includes interior central bore portions of differing bore diameters that enable the female plunger connector to be disconnected from the actuator in the pump cartridge.

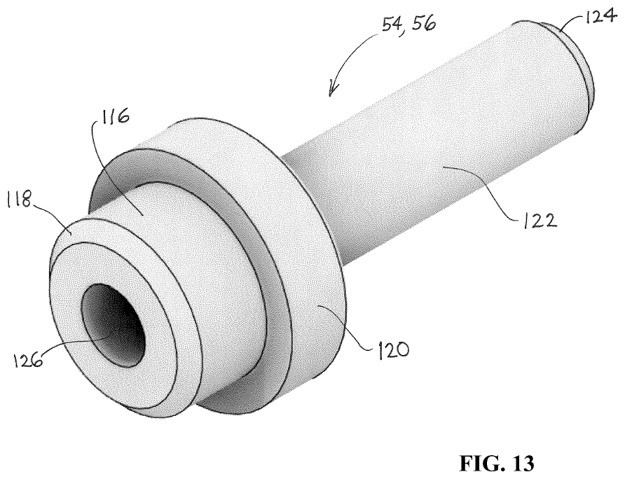

FIG. 13 is a perspective view of the rinse fitting 54, 56 of the pumplet subassembly. which are engaged with the headcap 38 as shown in FIG. 2. The rinse fitting includes a cylindrical proximal portion 116 with beveled proximal end portion 118, an intermediate cylindrical collar, a cylindrical main body portion 122, a beveled distal end portion 124, and a throughbore 126.

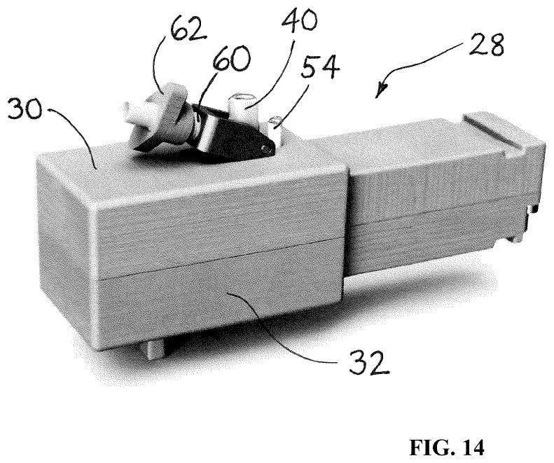

FIG. 14 is a perspective view of the pumplet subassembly as an assembled cartridge 28 with the pumplet top housing member 30 and the pumplet bottom housing member 32 being matably engaged with one another, and showing the upper end of the rinse fitting 54, the upper end of the outlet tower 40, the liquid outlet fitting 60, and the liquid outlet coupling 62.

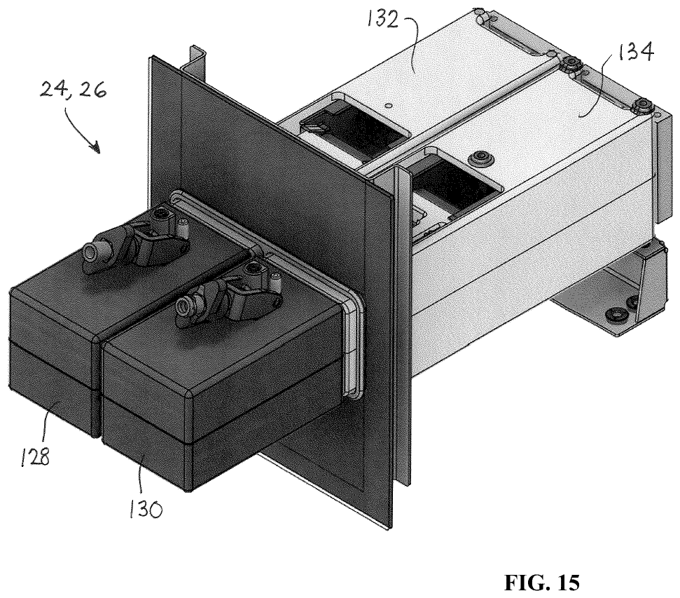

FIG. 15 is a perspective view showing a pump module 24, 26 comprising two pumplet subassemblies (pump cartridges) 128 and 130 operatively connected with pump drive motor, actuator, and controller subassemblies 132 and 134, respectively. Each pump drive motor, actuator, and controller subassembly include a pump drive motor providing sequential reciprocating drive and retraction force on the plunger in the associated pumplet subassembly, with the actuator acting to initiate the advancement and retraction of the plunger, and with the controller providing actuation and modulation signals to the actuator to effectuate the operational sequences of the pumplet subassembly as previously described, so that controller coordinates operation of the two pumplet subassemblies in the pump module to provide smooth flow at a command rate so that in liquid dispensing operation the pumplet subassembly sequentially, cyclically, and repetitively operates (i) as an active pumplet subassembly in a first operational dispensing stage and then (ii) as an alternate and non-dispensing pumplet subassembly in a refilling and transitional repressurization in a second operational standby stage, so that the pumplet subassembly correspondingly alternates between active dispensing operation in the first operational dispensing stage, and refilling and transitional repressurization operation in the second operational standby stage, with the controller switching the active dispensing operation from the active pumplet subassembly to the alternate and non-dispensing pumplet subassembly in which refilled liquid has been pressurized in the transitional repressurization operation in the alternate and non-dispensing pumplet subassembly to match active dispensing pressure of the active pumplet subassembly.

The controllers in the respective pump drive motor, actuator, and controller subassemblies 132 and 134 may be coupled or linked with one another, and/or may be operatively linked by suitable signal transmission lines or wireless connection to a central processing unit (CPU) that is programmably arranged to manage the controller elements in the respective pump drive motor, actuator, and controller subassemblies 132 and 134 so that they carry out the above-discussed operational sequence of controlled action in a coordinated and complementary manner so that liquid dispensing by the pump module comprising the two pumplet subassemblies is continuously carried out without the occurrence of spikes, surges, or other adverse variation of the pressure and flow rate of the dispensed liquid, and so that switching of active liquid dispensing operation between the respective pumplet assemblies involves no or extremely minimal variation of dispensed liquid pressure and flow rate during the switching transitions.

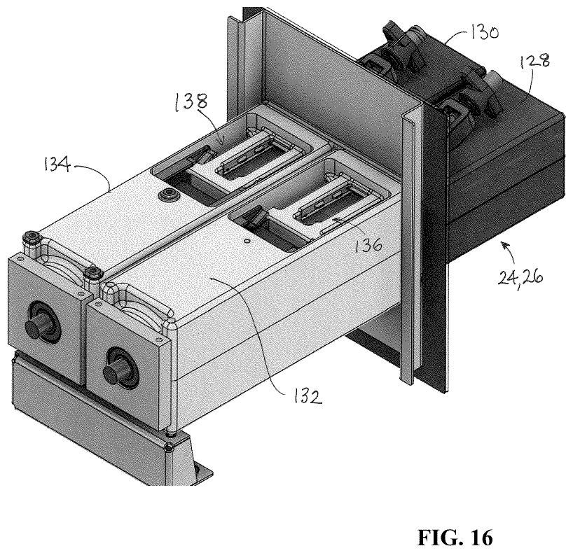

FIG. 16 is a reverse rear perspective view of the pump module of FIG. 15, showing the pump head retention tab mechanism 136 of the pumplet subassembly 128 and pump head retention tab mechanism 138 of the pumplet subassembly 130.

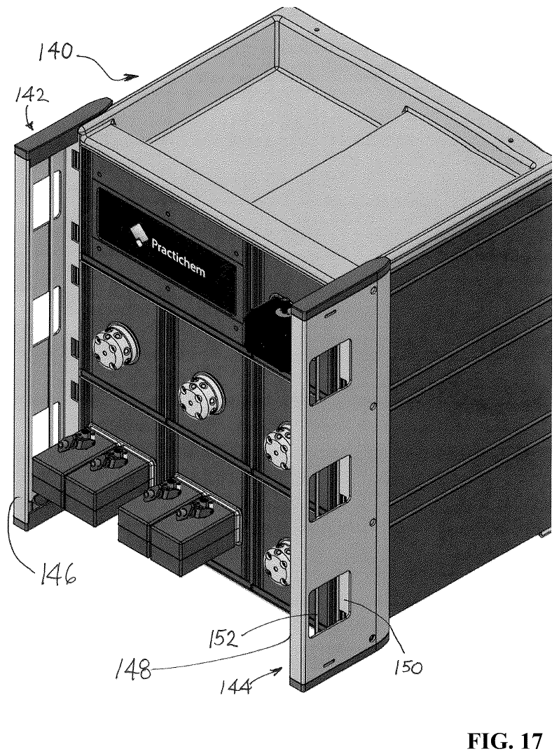

FIG. 17 is a perspective view of a liquid chromatography system 140 according to another embodiment of the present disclosure, similar to the liquid chromatography system 10 shown in FIG. 1, and including wing assemblies 142 and 144 configured for positional management of flow circuitry tubing in the liquid chromatography system.

Wing assembly 142 includes wing channel 146, and wing assembly 144 includes wing channel 148. Each of the wing channels includes multiple window openings 150 therein, and the corresponding wing assemblies include support rods 152 that are vertically upstanding and in proximity to the respective window openings in the wing assemblies. The support rods serve as elements to which tubing of flow circuitry utilized with the chromatography system can be supported, such as by alligator clips or other connector devices that secure the flow circuitry tubing to one or more of the support rods, to avoid loose and tangled and/or kinked flow circuitry tubing that may impair the operational utility of the chromatography system.

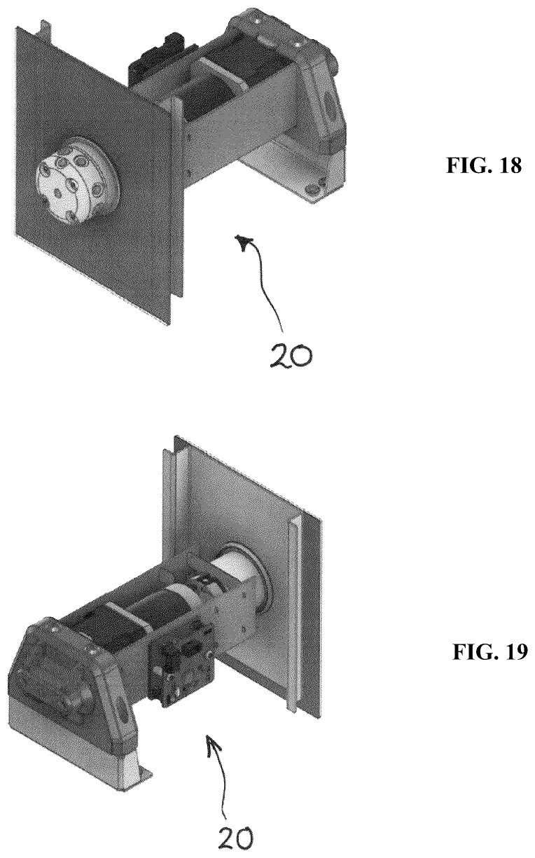

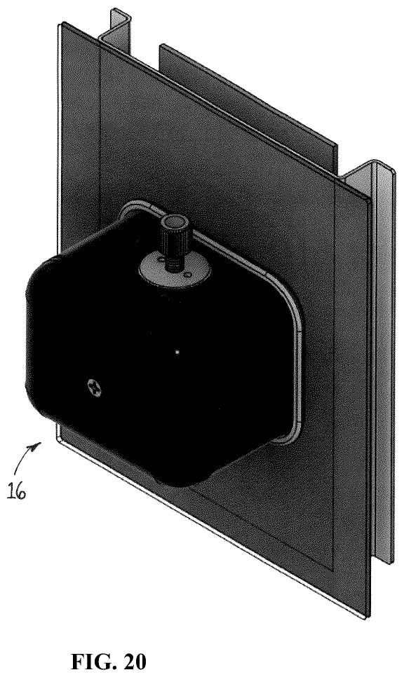

FIG. 18 is a front perspective view of a valve module 20 of the liquid chromatography system of FIG. 17 showing the compact character and modularity of such valve cartridge. FIG. 19 is a rear perspective view of the valve module of FIG. 18. FIG. 20 is a front perspective view of a detector module of the liquid chromatography system of FIG. 17.

It will therefore be appreciated that the liquid chromatography system according to the present disclosure embodies a highly efficient and small footprint apparatus for conducting chromatography processes, and that the tiered tray structure of the chromatography system together with the compact modular pump, valve, and detector cartridges minimizes the space requirements for the chromatography system and provides an apparatus configuration that simplifies and enhances the efficiency of chromatography operations.

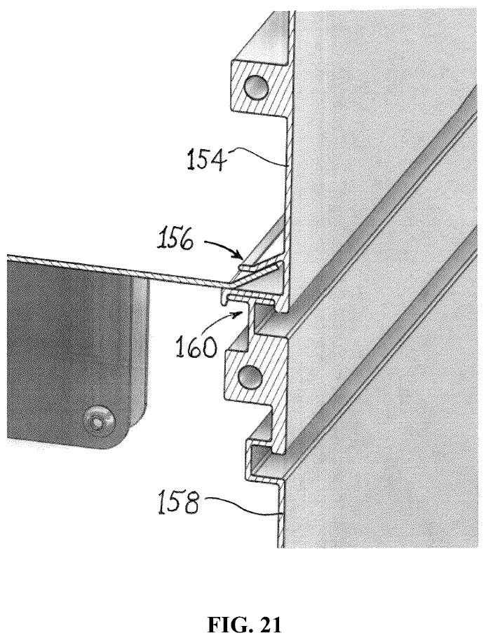

FIG. 21 is a schematic depiction of the interconnecting structure of successive tray sections in the tiered stacked array of tray sections in the liquid chromatography system of FIG. 17. The upper tray section 154 is reposed in stacked relationship on the lower tray section 158, with the upper tray section comprising upper tray section coupling structure 156 which includes a peripheral bottom channel structure having downwardly depending sides that matably engage the upper horizontal portion of the “T” shaped flange of the lower tray section coupling structure 160, so that the respective sections are firmly engaged with one another in the stacked array of tray sections.

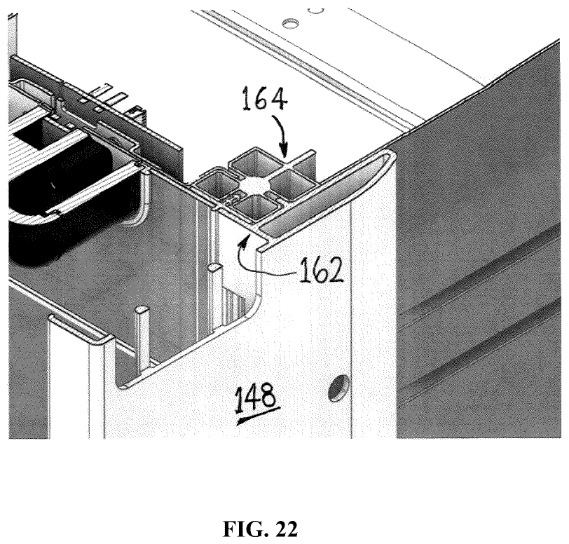

FIG. 22 is a schematic depiction of the interconnecting coupling structure of a wing channel 148 of a wing assembly and of respective tray sections in the tiered stacked array of tray sections in the liquid chromatography system of FIG. 17. As shown, the tray section is constructed with a corner portion thereof comprising the tray section coupling structure 164 in which front and side recesses are provided, which are engaged by the wing coupling structure 162 providing protrusion structures that are received in the corresponding recesses of the tray section coupling structure, so that the wing channel of the wing assembly can simply be inserted at a bottom end of the wing channel and the wing assembly then can be slid downwardly into place in the successively lower tray sections of the stacked array of tray sections in the chromatography system. Such coupling structure thereby enables a quick and effective assembly of the chromatography system whereby stacked tray sections can be consolidated with the reinforcement of the wing assemblies, to provide a conjoined structure that serves to protect the components on the front face of the chromatography system as well as providing the aforementioned capability for anchored sections of flow circuitry tubing that are clipped or twist-tied by corresponding clip or twist tie couplings to the vertical support rods and thereby are accessible from either side of the wing channel, including being exteriorly accessible through the window openings in the wing channel.

The pump of the present disclosure may additionally incorporate strain compensation features to ensure precise control of liquid dispensing by the pump, in which a monitoring and control system associated with the pump receives input indicative of strain in the system that if uncompensated would cause the flow rate of the liquid dispensed by the pump to vary from the command liquid dispensing flow rate. The monitoring and control system correspondingly adjusts the liquid dispensing rate of the active dispensing pumplet subassembly in the pump to compensate the strain effect and controllably maintain the command liquid dispensing flow rate.

In a specific implementation, position of each female plunger connector 52 relative to the pumplet actuator housing in the pump head drive motor, actuator, and controller subassembly 132, 134, and specifically relative to the housing's flexural member (pump head retention tab mechanism 136, 138) is sensed by a position sensor.

The position sensor enables the pump monitoring and control system to (i) confirm the presence of the female plunger connector 52, indicating that the pump head has been inserted into the actuator, (ii) verify that the female plunger connector is moving as intended, inferentially indicating that the female plunger connector is properly connected to the male plunger connector in the connected assembly of the female plunger connector 52 and male plunger connector, and (iii) receive from the position sensor a position input indicative of position of the female plunger connector relative to the flexural member of the pump head retention tab mechanism.

The position input transmitted from the position sensor to the pump monitoring and control system then is processed by a controller in the pump monitoring and control system to modulate the operation of the pumplet subassembly to compensate for the strain in the actuator housing, by adjusting the translational speed of the plunger in the pumplet subassembly, so that the command liquid dispensing rate is achieved in the active dispensing pumplet subassembly.

Thus, the pump monitoring and control system compensates the strain that results from and is proportional to the force experienced by the pumplet subassembly components that drive the fluid forward from the pumplet subassembly in the active dispensing operation, including the pump drive motor, ball screw, and plunger assembly comprising the male and female plunger connectors. This force varies with fluid pressure, and if the associated strain is not compensated, then the pumplet subassembly will output a lower volume than commanded.

While the foregoing discussion is directed to strain compensation in the active dispensing pumplet subassembly in which the pump monitoring and control system produces a strain-compensated pumping action to achieve the command liquid dispensing rate, it will be appreciated that the pump monitoring and control system in various other embodiments may additionally be constructed and arranged so that corresponding strain compensation takes place in the non-dispensing standby pumplet subassembly, in which the pump monitoring and control system adjusts the translational speed of the plunger in the refilling and transitional repressurization operation to compensate for the strain in the actuator housing so that command refilling and repressurization rates are achieved.

Position sensors in the above-described strain compensation arrangements of the pump and associated pump monitoring and control system may be of any suitable type and arrangement.

For example, electronic induction sensors may be employed, including an array of overlapping flat coils that are positioned out of phase with respect to one another, in which wire loop induction and eddy currents are utilized to detect the position of the female plunger connector that is moving above the array of coils, to generate an output signal that is indicative of the female plunger connector position. Electronic in induction sensors of such types are readily commercially available, including for example the ZMID4200 inductive position sensor commercially available from Renesas Electronics Corporation, Tokyo, Japan.

Other types of position sensors may alternatively be employed, including magnetic (e.g., Hall effect) sensors, capacitive sensors, optical encoder sensors, linear variable differential transformer (LVDT) sensors, and the like, although the disclosure is not limited thereto.

The pump monitoring and control system may also be constructed and arranged to compensate effects of placement of the position sensor, such as remaining strain of the pumplet top and bottom housing members 30, 32, in which the strain is linearly proportional to the strain in the actuator of the pump head drive motor, actuator, and controller subassembly 132, 134, and can be correspondingly compensated on the basis of such linear relationship.

In various embodiments, in addition to or substitution for the position sensor, a pressure sensor may be employed in the pumplet subassembly to generate a strain-correlated output that is then utilized by the pump monitoring and control system to compensate the strain in the pumplet subassembly. For example, a pressure sensor could be embedded in the pump head chamber 42, or in a downstream flow locus, e.g., at or downstream of the pump valve tower liquid outlet 58.

It will therefore be appreciated from the foregoing description that the pump and chromatography system of the present disclosure may be correspondingly constructed and arranged to monitor and compensate strain effects in the pump in a highly efficient and effective manner providing precision-controlled dispensing of liquid.

It will also be more generally appreciated that the pumps, pumplet subassemblies, chromatography systems and chromatography system components described herein achieve a remarkable level of compactness, efficiency, and operational enhancement in chromatography equipment and associated chromatography processes.

The pumps and chromatography systems of the present disclosure are adaptable to operation in widely varying chromatographic process conditions, and with widely varying stationary and mobile phases. The pumps of the present disclosure are effective to achieve remarkably constant and continuous liquid flow rates and linear flow velocities, without the occurrence of perturbations or hydrodynamic anomalies. As a result, the chromatographic systems of the present disclosure comprising such pumps achieve markedly superior chromatographic separations as compared to systems utilizing pumps of prior conventional character.

While the disclosure has been set forth herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the disclosure as hereinafter claimed is intended to be broadly construed and interpreted, as including all such variations, modifications and alternative embodiments, within its spirit and scope.

A listing of reference numerals of the drawings and associated structural elements or assemblies is set out below for reference.

### REFERENCE NUMBER

10 liquid chromatography system
12 top tray section
14 touch screen input/output display
16 detector module
18 middle tray section
20 valve module
22 bottom tray section
24 pump module
26 pump module
28 pump cartridge (pumplet subassembly)
30 pumplet top housing member
32 pumplet bottom housing member
34 bearing tube
36 diaphragm
38 headcap
40 outlet tower
42 chamber
44 sleeve
46 inlet tower
48 endcap
50 mechanical fasteners
52 female plunger connector
54 rinse fitting
56 rinse fitting
58 liquid outlet
60 liquid outlet fitting
62 liquid outlet coupling
64 mechanical fasteners
66 liquid outlet opening
68 rinse fitting opening
70 liquid inlet opening
72 rinse fitting opening
74 larger diameter proximal cylindrical portion of the bearing tube
76 smaller diameter main body portion of the bearing tube
78 cutout
80 cutout
82 diaphragm central opening
84 outlet rinse fitting opening
86 outlet tower cutout
88 plunger shaft passage
90 rinse liquid inlet passage
92 plunger shaft opening
94 cam-configured base
96 outlet port
98 purge valve port
100 priming injection port
102 mechanical fastener passages
104 cutout
106 cutout
108 inlet tower inlet port
110 cam-configured head
112 mechanical fastener passages
114 central bore
116 cylindrical proximal portion
118 beveled proximal end portion
120 cylindrical collar
122 cylindrical main body portion
124 beveled distal end portion
126 throughbore
128 pump cartridge (pumplet subassembly)
130 pump cartridge (pumplet subassembly)
132 pump head drive motor, actuator, and controller subassembly
134 pump head drive motor, actuator, and controller subassembly
136 pump head retention tab mechanism
138 pump head retention tab mechanism
140 liquid chromatography system
142 wing assembly
144 wing assembly
146 wing channel
148 wing channel
150 window opening
152 support rod
154 upper tray section
156 upper tray section coupling structure
158 lower tray section
160 lower tray section coupling structure
162 wing coupling structure
164 tray section coupling structure

What is claimed is:

1. A liquid pump, comprising:
two pumplet subassemblies, each comprising an actuator and a pump head;
a controller adapted to coordinate operation of the two pumplet subassemblies to provide smooth flow at a command rate so that in liquid dispensing operation each pumplet subassembly sequentially, cyclically, and repetitively operates (i) as an active pumplet subassembly in a first operational dispensing stage and then (ii) as an alternate and non-dispensing pumplet subassembly in a refilling and transitional repressurization in a second operational standby stage, so that each pumplet subassembly correspondingly alternates between active dispensing operation in the first operational dispensing stage, and refilling and transitional repressurization operation in the second operational standby stage, with the controller switching the active dispensing operation from the active pumplet subassembly to the alternate and non-dispensing pumplet subassembly in which refilled liquid has been pressurized in the transitional repressurization operation in the alternate and non-dispensing pumplet subassembly to match active dispensing pressure of the active pumplet subassembly.

2. The liquid pump of claim 1, configured so that in the refilling in the second operational standby stage, the plunger of the non-dispensing alternate pumplet subassembly is retracted to refill the pump chamber, while the plunger of the other previously filled pumplet subassembly is advanced in dispensing operation, with the refilling of the non-dispensing alternate pumplet subassembly controlled so that the refilling is completed in less time than the dispensing operation conducted in the active dispensing pumplet subassembly, to allow time for the refilled pumplet subassembly to accommodate pre-compression in the transition step.

3. The liquid pump of claim 2, wherein in the transition step, as the active dispensing pumplet subassembly approaches the end of its stroke, the plunger in the refilled standby pumplet subassembly is advanced to compress the refill liquid to match the pump's current operating pressure, but without any dispensing from the pressurizing standby pumplet subassembly until the pressure match is achieved, with the plunger of the active subassembly slowing while the plunger in the standby pumplet subassembly accelerates, and at pressure match, the dispensing operation is transferred from the from the formerly active pumplet subassembly to the pressurized standby pumplet subassembly, so that the latter commences dispensing operation, while the formerly active pumplet subassembly then undergoes refill and transition steps, to achieve continuity of dispensing operation.

4. The liquid pump of claim 3, wherein at transfer of dispensing operation from the formerly active pumplet subassembly to the pressurized standby pumplet subassembly, the velocity vectors of the respective plungers in the two pumplet subassemblies are constant.

5. The liquid pump according to claim 1, wherein the pump is arranged to receive operational commands from the controller to adjustably modulate the pump operation, and the pump is arranged so that upon receiving an operational command to increase its flow rate, the refill velocity of the plunger in the alternate pumplet subassembly is adjusted so that the refilling of the pump chamber in such alternate pumplet is completed in a correspondingly shorter period of time to accommodate the transfer of dispensing operation at the command increased flow rate.

6. The liquid pump according to claim 1, wherein the controller is operable to place the pump in a shut down or parked state, in which the plungers in both pumplet subassemblies are fully extended into their respective pump chambers, for storage or transport of the pump.

7. The liquid pump according to claim 1, wherein the pump head of a pumplet subassembly is releasable from the pumplet subassembly by a control signal that is transmitted by the controller to the actuator plunger driver so that the plunger driver effects movement of the plunger to a hyper retraction point, which disconnects a plunger male connector connection spring from a plunger female connector groove, and disengages actuator pump head retention tabs from grooves in the pump head.

8. The liquid pump according to claim 1, wherein:
the pump head is removable by withdrawal of the pump head from an actuator receiver, and subsequent pump head removal is sensed by a male plunger linear position sensor;
the pump head is removable from the pumplet subassembly by actuation of a plunger driver to extended to a pump head load position at which pump head retention tabs relax and are free to be lifted, whereby the pump head is removable from the actuator receiver of the pumplet subassembly; a replacement pump head is engageable with the pump head retention tabs by insertion of the replacement pump head in the actuator receiver, with replacement pump head retention tabs engaging pump head grooves in the replacement pump head;
replacement pump head insertion is sensed by a position sensor; and
the replacement pump head is connectable for operation by extension of an actuator plunger driver that advances the plunger into the pump head so that a plunger male connector engages a plunger female connector.

9. The liquid pump according to claim 1, wherein liquid flow direction is maintained by two sets of non-return valves that direct liquid upwardly through the pump.

10. The liquid pump according to claim 1, comprising a hollow cylinder with a barrel vaulted ceiling structure defining a pump chamber, one end of the pump chamber being closed, and open at another end to receive a movable plunger, arranged with a plunger seal received by a seal gland, and with the chamber connected to liquid inlet and liquid outlet ports.

11. The liquid pump according to claim 1, comprising two valve towers including non-return valve stacks that allow liquid flow upwards from a bottom inlet to a top outlet, with reverse flow being blocked, wherein the valve stacks comprise a stack of two ball and seat groups and a plain spacer at the bottom of the valve tower assembled into a header connecting the pump chamber to a tube fitting, wherein each valve tower and stack is sealed against a chamber port by force applied by a cam-in-groove mechanism, and wherein the plain spacer engages a radial groove with progressively increasing radius cut in the exterior surface of the chamber.

12. The liquid pump according to claim 11, wherein each non-return valve stack comprises ball and seat elements wherein the ball comprises a spherical polished ruby ball and the seat comprises a sapphire ring in which a mating surface of engagement of the seat and ball seals at a theoretically perfect circle, and wherein the ball is enclosed in a ball spacer that allows the ball to move, but maintains valve stack integrity around the ball, with the ball spacer including a slot configured so that fluid can flow around the ball in one direction.

13. The liquid pump according to claim 1, comprising a chamber inlet port located at a lower proximal end of the chamber, in proximity to a closed end thereof, and a chamber outlet port located at an upper distal end of the chamber, in a barrel vaulted ceiling, adjacent to a plunger seal, whereby entrained gas bubbles in liquid in the chamber are concentrated and transported to the chamber outlet port.

14. The liquid pump according to claim 1, including an outlet header comprising a manual prime and purge valve connectable to a liquid injector to prime the pump, or openable to allow venting of bubbles from liquid in the pump.

15. The liquid pump according to claim 1, comprising a rinse system comprising a flexible resilient diaphragm mounted on a plunger shaft so that the diaphragm flexes according a direction of travel of the plunger shaft in a rinse locus configured to receive rinse liquid from a source of same so that the rinse liquid is pumped by the diaphragm through the rinse locus to contact and remove contaminants from an external surface of the plunger shaft in the rinse locus.

16. The liquid pump according to claim 1, comprising a motor and ballscrew constituting a motive driver for the pump, wherein the motor comprises a stepper motor, and wherein the ballscrew is mounted in a thrust and radial bearing assembly.

17. The liquid pump according to claim 1, comprising a pump head and a plunger driver including a cam mechanism in an actuator housing including a retention tab that follows a cam profile of the cam mechanism for latching or unlatching the pump head.

18. The liquid pump according to claim 1, comprising a monitoring and control system, including a sensor arranged to provide an output correlative of strain in the pumplet subassembly to a controller of the monitoring and control system so that the controller responsively adjusts the liquid dispensing rate of the pumplet subassembly during active dispensing operation to compensate the effect of said strain.

19. A liquid chromatography system comprising a liquid pump according to claim 1.

20. The liquid chromatography system of claim 19, comprising:
a tiered stacked array of tray sections with at least one of the tray sections having the liquid pump removably mounted therein;
wing assemblies mounted at one or both front sides of the tiered stacked array of tray sections; and window openings in the wing assemblies and support rods in proximity to the window openings for securing flow circuitry tubing to the support rods.
